(19) United States
(12) Patent Application Publication
(10) Pub. No.: US 2005/0164752 A1
(43) Pub. Date: Jul. 28, 2005

(54) Palm-size foldable computing and communication assembly for personal users

(76) Inventors: Stephen Lau, Vancouver (CA); Freeman Fan-Yien Lee, Burnaby (CA); Yu Hsin Fan, Burnaby (CA)

Correspondence Address: Dennison, Schultz & Dougherty & MacDonald, Suite 105, 1727 King Street, Alexandria, VA, 22314, US

(21) Appl. No.: 10/762,371

(22) Filed: Jan. 23, 2004

(51) Int. Cl. H04B 1/00

(52) U.S. Cl. 455/575.3; 455/575.1

(57) ABSTRACT

A palm-size foldable personal computing and communications assembly that comprises a first folding set and a second folding set. When folded, the front panel of the first folding set is a portable mobile telephone, and on the back panel in the expanded form is a display screen. The main components of a computer are installed in the segments to form a portable personal computer. The second folding set in expanded form is a membrane keyboard, and the membrane keyboard can be connected to the first folding set through an infrared transmitter. Jacks for external inputs and a battery are also provided. The battery is used to power the first and second folding sets. The present invention provides a convenient platform for personal users, which can perform multiple applications to satisfy their personal computing and wireless communications needs.

### BACKGROUND OF THE INVENTION

1. Field of the Invention

The present invention relates to a palm-size foldable computing and communication assembly for personal users, in particular, an integrated assembly that is a mobile telephone when the assembly is in a fold-back form and a portable computer when the assembly is in an expanded form. Versatile communication capabilities allow a user to log on to the Internet any place and any time, thus providing a virtual business office anywhere.

Technological inventions such as telephones, computers and satellite receivers have greatly improved the life of human beings, providing modern conveniences and improving our working conditions. Because these electronic devices are often created for a single application, modern offices and homes often have many conventional electronic gadgets, and the situation is becoming unmanageable. If the functions of a conventional telephone, portable computer, copier, camera and satellite transceiver could be integrated into one assembly, business people would no longer need to carry or borrow these pieces of equipment on business trips or when they are out of the office. All they would need is a dynamic product like the present invention that has brought together most of the office functions in a personal portable assembly. With ingenuous design and efficient production means, this type of all-in-one personal assembly can be produced at a reasonably low cost, so that most end users would be able to afford to purchase one for their personal use. Furthermore, the integration of the satellite communication capability on a mobile phone enables users to avoid the situation of having to pay a surcharge for transferring a call through the local switching network and international telephone service. Whenever they travel abroad, they only need a fixed dialing number to establish satellite communication from any place in the world. The present invention allows end users to create new business opportunities without the space and time constraints previously applied. At the same time, the present invention can be delivered to the hands of a consumer at a reasonable price. For the end users, how to integrate the functions existing on various electronic products, make a product easy to operate and keep the cost down are some of the high priorities for further improvements.

### SUMMARY OF THE INVENTION

The main object of the present invention is to provide a palm-size foldable computing and communication assembly for personal users, which integrates the functions of a conventional telephone, computer and satellite receiver and router, and has created a new powerful machine with multiple functions.

A first folding set and a second folding set together form a palm-size foldable computing and communication assembly for personal users.

When placed in a fold-back form, the front panel of the first folding set is a mobile phone, and the back panel becomes a display screen when placed in an expanded form. The main components of a computer are installed behind the panels to form a portable computer.

The second folding set when expanded is a membrane keyboard which is connected to the first folding set through an infra red transmission or bluetooth means, and the assembly has built-in jacks for accepting external input and a battery to provide the operating voltage to the first and second folding sets.

This all-in-one multi-function machine mentioned above can fully satisfy the computing and communication needs of a business user as well as a home office user.

The second folding set is a standard keyboard used to support the first folding set; therefore it has to be connected to the first folding set during assembly operation. The features and structure of the present invention will be more clearly understood when taken in connection with the accompanying figures.

### BRIEF DESCRIPTION OF THE DRAWINGS

FIG. 1 is a perspective view of a palm-size foldable computing and communication assembly for personal users in accordance with the present invention;

FIG. 2 is a front plan view of the first folding set of the palm-size foldable computing and communication assembly in FIG. 1 in folded form;

FIG. 3 is a left side plan view of the first folding set in FIG. 2;

FIG. 4 is a perspective view of the first folding set in FIG. 2 partially expanded;

FIG. 5 is a top plan view of the first folding set in FIG. 2 in folded form;

FIG. 6 is a bottom plan view of the first folding set in FIG. 2 in folded form;

FIG. 7 is a perspective view of the front side of the second folding set in FIG. 1 partially expanded.

### DETAILED DESCRIPTION OF THE PREFERRED EMBODIMENT

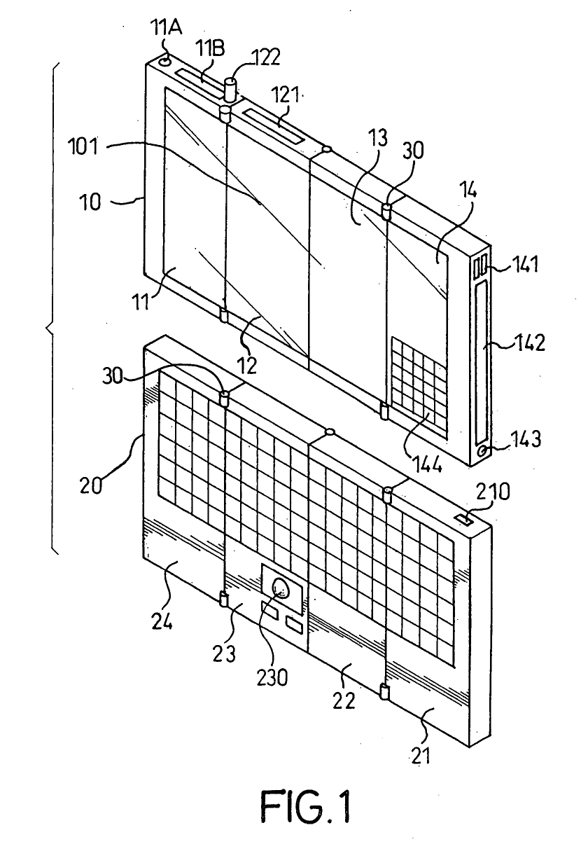

With reference to FIG. 1, a palm-size foldable computing and communication assembly for personal users in accordance with the present invention comprises a first folding set (10) and a second folding set (20). The first folding set (10) is a foldable computer and telephone, and the second folding set (20) is a foldable keyboard.

The first folding set (10), the computer and telephone, comprises a first segment (11), a second segment (12), a third segment (13) and a fourth segment (14). The segments (11, 12, 13, 14) are interconnected by hinges (30) to accordion fold the first folding set (10).

Each segment is an independent unit resembling a rectangular block. Each segment consists of six panels: a front panel, a back panel, a left side panel, a right side panel, a top panel and a bottom panel.

For purposes of orientation, the following reference to “left” and “right” refer to the segments (11, 12, 13, 14) when view from the front. The top left and bottom left corners on the back panel of the first segment (11) and the top right and bottom right corners on the back panel of the second segment (12) are connected by hinges (30) the top left and bottom left corners on the front panel of the second segment (12) and the top right and bottom right corners on the front panel of the third segment (13) are connected by hinges (30). The top left and bottom left corners on the back panel of the third segment (13) and the top right and bottom right corners on the back panel of the fourth segment are connected by hinges (30).

With reference to FIG. 1, 2 and 3, when the first folded set (10) is folded, the front panel of the first segment (11) is a mobile phone. When the first folded set (10) is expanded, the back panel is a full-screen display (101), and a touch keypad (144) is on the lower portion of the fourth segment.

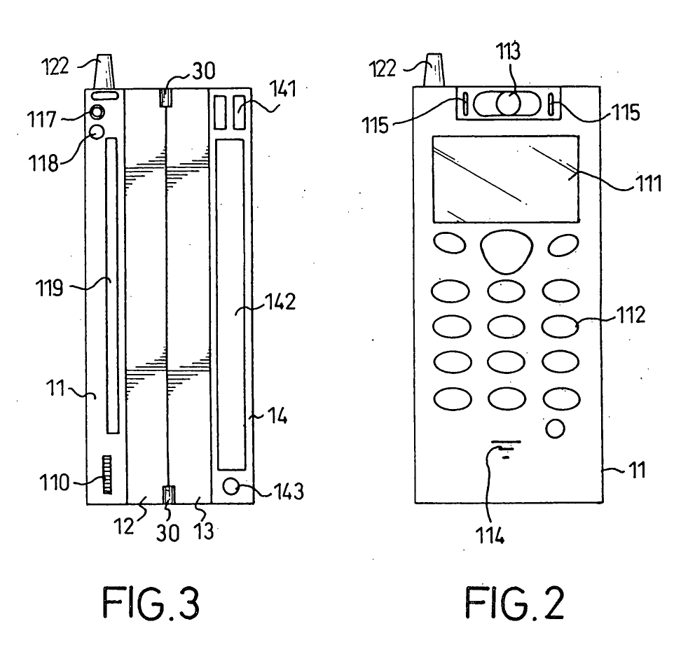

With reference to FIG. 2, a CCD camera (113) is installed near the top of the first segment (11) behind the front panel, with a telephone earpiece (115) on each side. A mobile phone keypad (112) with multiple keys is mounted in the center of the front panel, and a microphone (114) is installed below the mobile phone keypad (112). A display (111) is mounted between the CCD camera (113) and the mobile phone keypad (112). A mobile phone antenna (122) is mounted on the left hand side of the top panel.

With reference to FIG. 3, a power switch (116) is mounted near the top of the right side panel of the first segment (11) of the first folding set (10), and a floppy disk slot (119) is formed in the center of the right side panel. A volume control knob (110) is mounted near the bottom of the right side panel. An earphone jack (117) and a microphone jack (118) are mounted between the power switch (116) and the floppy disk slot (119). Two USB ports (141) are mounted near the top of the left side panel of the fourth segment (14), and a CD slot (142) is mounted in the center of the left side panel. A charging jack (143) is mounted between the CD slot (142) and the bottom of the left side panel.

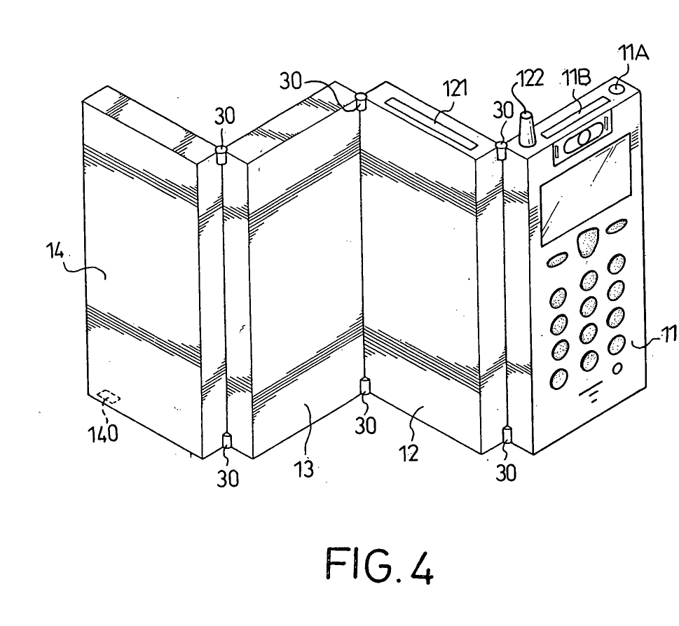

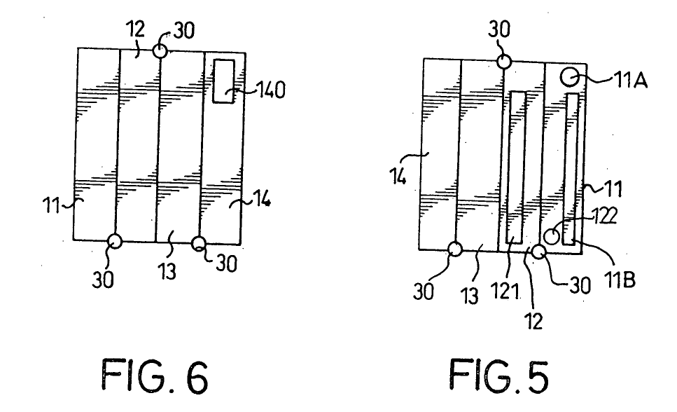

With reference to FIGS. 4 and 5, the first folding set (10) further comprises a satellite receiver and router (11A), a credit card sensor slot (11B), a card reader (121) and an antenna (122). The satellite receiver and router (11A) and the credit card sensor slot (11B) are mounted on the top panel of the first segment (11), and the card reader (121) and the antenna (122) are respectively mounted on the top panel of the second segment (12) and first segment (11). With reference to FIG. 6, a first infrared or bluetooth port (140) is mounted on the bottom of the fourth segment (14) to interconnect with the second folding set (20) by wireless communication through a second infrared or bluetooth port (210) mounted on the top panel of the first segment (21) of the second folding set (20).

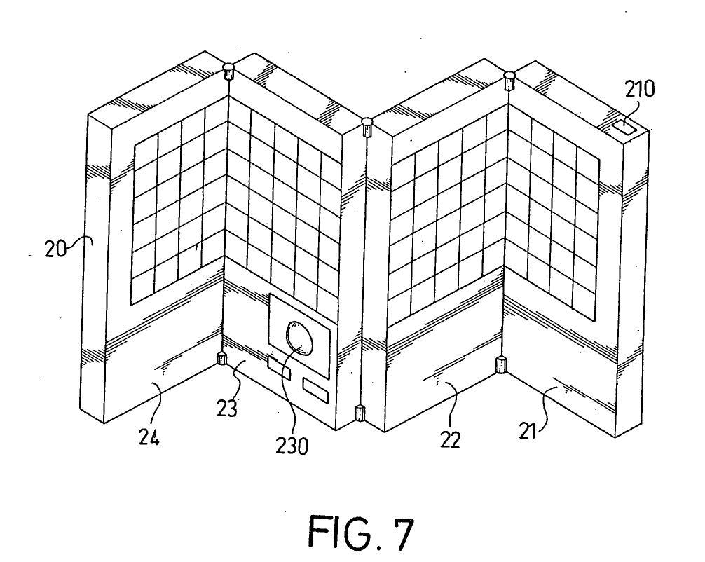

With reference to FIG. 7, the second folding set (20) also has four segments. When fully expanded, the second folding set (20) is a standard membrane keyboard assembled from four segments (21˜24) linked by hinges. Multiple battery cells (not shown) are mounted inside four segments (21˜24), and a track ball (230) is mounted on the lower portion of the third segment (23).

With reference to FIG. 2, under normal conditions, the palm-size foldable computing and communication assembly for personal users is folded. The front panel of the first segment (11) of the first folding set (10) is a mobile phone for wireless and satellite communication. When the first folding set (10) is fully expanded, the back panel becomes a display screen (101) for an embedded computer. With a touch keypad (144) mounted in the fourth segment, the embedded computer and the display screen (101) form a portable computer. The computer can be further linked with the mobile phone and satellite receiver and router (11A) on the first segment for networking and wireless transmission, in effect creating a mobile business office. Data can be retrieved and saved on storage media by using the CD slot (142) and the floppy drive slot (119). The credit card sensor slot (11B) provides the convenience of mobile banking service. If a user is not familiar with the touch keypad (144), he or she can use the standard membrane keyboard on the second folding set (20) to input data by connecting the membrane keyboard. An extra battery housed inside the keyboard is also added to the assembly to allow the assembly standby time to be extended even further.

The foldable computer and telephone set in the palm-size foldable computing and communication assembly for personal users in accordance with the present invention is capable of establishing communication links through satellites and providing the following features through wireless means:
1. palm-size computer with IR transmission capability;
2. three dimensional vision capturing and transmission;
3. logging on to Internet and networking;
4. voice recognition;
5. printing, facsimile and recording services;
6. credit card verification and smart card device;
7. digital camera input output;
8. satellite VoIP option
9. multicast streaming over satellite option,
10. wireless VoIP

From the foregoing, the palm-size foldable computing and communication assembly for personal users has combined all the foregoing features in one assembly, with a creative configuration and functional improvements over the conventional products. The foregoing illustration of the preferred embodiments in the present invention is intended to be illustrative only, under no circumstances should the scope of the present invention be so restricted.

1. A palm-size foldable computing and communication assembly for personal users, the assembly comprising:
a first folding set functioning as a foldable computer and telephone set made up of multiple folding segments, wherein a mobile phone, display screen and computer components are respectively installed; and
a second folding set functioning as a foldable membrane keyboard set, made up of multiple folding segments, wherein a keyboard and a battery are respectively installed.

2. The assembly as claimed in claim 1, wherein the first folding set is formed by a first, second, third and fourth segment, with hinges on top and bottom of adjacent segments interconnecting all the segments.

3. The assembly as claimed in claim 2, wherein a CCD camera is installed near the top inside the front panel of the first segment of the first folding set, two telephone earpieces are installed with one on each side of the CCD camera, a central mobile phone keypad with multiple keys is installed in the central portion of the front panel, a microphone is installed on the lower portion of the front panel, and a display screen is installed between the CCD camera and the mobile phone keypad.

4. The assembly as claimed in claim 2, wherein a power switch is mounted in the upper portion of the right side panel of the first segment, and a floppy drive slot is formed in the center portion of the right side panel of the first segment, a volume control knob is mounted near the bottom, and a earphone jack and a microphone jack are mounted between the power switch and the floppy drive slot.

5. The assembly as claimed in claim 2, wherein two USB ports are fixed on the top portion of the left side panel on the fourth segment, a CD slot in the center, and a charging jack in the lower portion.

6. The assembly as claimed in claim 2, wherein a satellite receiver with router option and a credit card sensor slot are mounted on the top panel of the first segment, and an infra red transmitter port is mounted on the bottom panel of the fourth segment.

7. The assembly as claimed in claim 2, wherein an antenna and card reader are respectively installed on the top panel of the second segment and first segment on the first folding set.

8. The assembly as claimed in claim 2, wherein a first infrared port (140) is mounted on the bottom of the fourth segment (14) of the first folding set.

9. The assembly as claimed in claim 2, wherein a large-screen display is mounted on the back panel of the second folding set when the second folding set is fully expanded, and a touch keypad is mounted on the lower portion of the back panel of the fourth segment.

10. The assembly as claimed in claim 1, wherein when fully expanded the second folding set is a standard membrane keyboard, formed by a first second, third and fourth segment interconnected by hinges, with multiple battery cells housed inside the four segments.

11. The assembly as claimed in claim 9, wherein a track ball is mounted on the lower portion of the front panel of the third segment of the second folding set.

12. The assembly as claimed in claim 9, wherein a second infrared port is mounted on the top panel of the first segment of the second folding set.

13. The assembly as claimed in claim 6, wherein the satellite receiver provides the function of satellite VoIP data transmission.

14. The assembly as claimed in claim 6, wherein the satellite receiver provides the function of multicast streaming.

15. The assembly as claimed in claim 6, wherein the satellite receiver provides the function of wireless VoIP data transmission.
